(19) United States
(12) Patent Application Publication
(10) Pub. No.: US 2026/0117527 A1
(43) Pub. Date: Apr. 30, 2026

(54) WALL COVERING, TOP LAYER AND METHOD

(71) Applicants: AHOLDING B.V., Eersel (NL); CE HOLDING B.V., Eersel (NL)

(72) Inventors: Martijn Bernardus Gerardus Verhoeven, Eersel (NL); Kirsty Manon Van Beek, Eersel (NL)

(73) Assignees: AHOLDING B.V., Eersel (NL); CE HOLDING B.V., Eersel (NL)

(21) Appl. No.: 19/159,387

(22) PCT Filed: Jan. 31, 2024
(86) PCT No.: PCT/IB2024/050880

§ 371 Date: Aug. 25, 2025

(30) Foreign Application Priority Data
Feb. 23, 2023 (NL) 2034210

(51) Int. Cl. E04F 13/08; B32B 5/02; B32B 5/18; B32B 5/24; B32B 7/12

(52) U.S. Cl. CPC E04F 13/0866; B32B 5/022; B32B 5/18; B32B 5/245; B32B 7/12; E04F 13/0885; B32B 2255/02; B32B 2266/0235; B32B 2266/0278; B32B 2266/06; B32B 2307/102; B32B 2307/724; B32B 2307/7376; B32B 2451/00; B32B 2607/02

(57) ABSTRACT

A wall covering comprises a base layer of a number of successive and mutually adjacent drops of an acoustically damping material and of a first thickness. The base layer is covered with an air-permeable top layer extending over at least a number of drops. The top layer is connected to the drops with interposing of a heat-activated adhesive layer. A method is provided for applying the wall covering.

The present invention relates to a wall covering, comprising a base layer of a number of successive and mutually adjacent drops of an acoustically damping material and a first thickness. The invention therewith relates more specifically to an acoustically damping and ambient sound-suppressing wall covering, also referred to hereinafter simply as acoustic wall covering. The invention also relates to a method for applying a wall covering. It is noted here that where the present application refers to a wall, this is understood to mean not only the upright walls bounding a space but, on the contrary, also any other wall that affects the acoustics in a space, particularly also a ceiling, roof or floor of the space, but for instance also partition walls and parts of furniture placed in the space.

A known acoustically damping wall covering is arranged in the manner of wallpaper over a full height of one or more upright walls of a space in drops with a width in the order of 80 to 150 centimetres. For the sake of the intended acoustically damping properties, the material of the material used for the drops has a certain minimum thickness and thereby has a relatively heavy weight compared to standard paper or fleece wallpaper. Arranging such a thick layer therefore requires considerable skill, not in the least due to the adhesive layer which is used for application and with which the drops are adhered to the base surface. It has particularly been found impossible, or hardly possible, to arrange the drops adjacently of each other in seemingly seamless manner; even for an experienced skilled person.

In addition, the known acoustic material can be manufactured and applied only in limited dimensions. Modern printers are particularly unsuitable for printing the relatively thick acoustic material if it has a width of more than 120 centimetres at any random length. This makes it impossible to provide a larger wall with a continuous print over its full surface, while this would in many cases be desirable from an interior design viewpoint.

The present invention has for its object, among others, to provide a wall covering which obviates the above stated drawbacks to at least significant extent.

In order to achieve the stated object a wall covering of the type described in the preamble has the feature according to the invention that the base layer is covered with an air-permeable top layer, that the top layer extends over at least a number of drops, and that the top layer is connected to the drops with interposing of a heat-activated adhesive layer. Because the top layer extends over a number of drops of the base layer, the top layer covers up the intermediate seams between the drops. The seams are thus concealed from view by the top layer, even where they would otherwise be annoyingly visible. This allows the acoustically damping drops to be arranged with less precision. A heat treatment, of a type which is not all that critical, finally suffices for realizing an adhesion between the top layer and the base layer, whereby a less experienced skilled person or even a do-it-yourselfer should be capable of applying the wall covering according to the invention.

The top layer can take a relatively thin form since it does not require the acoustically damping properties which are already provided by the base layer. The air-permeable properties of the top layer allow sound waves to penetrate through the top layer and subsequently be absorbed in the base layer. A preferred embodiment of the wall covering therefore has the feature according to the invention that the top layer has a second, smaller thickness than the first thickness of the base layer. Because the top layer is relatively thin, it can be arranged in relatively simple manner; no more or hardly any more difficult than normal paper or fleece wallpaper.

A further embodiment of the wall covering according to the invention is particularly characterized in that the drops collectively span a surface and that the top layer extends over the whole surface. One or more surfaces, particularly one or more walls of a space, can thus be covered entirely with the drops of the base layer, after which the top layer is arranged thereover over the full surface. This achieves a completely seamless whole which has an acoustic effect below the surface. Applying a relatively thin top layer furthermore enables corners between adjacent surfaces to be seamlessly spanned thereby.

With a view to optimal acoustically damping properties a preferred embodiment of the wall covering has the feature according to the invention that the acoustically damping material has an open cell structure, particularly a felt or polymer foam with an open cell structure, more particularly a foam of a polymer from a group comprising urea-formaldehyde (UF), polyurethane (PUR), polyisocyanurate (PIR), phenol formaldehyde (PF) and polyvinyl chloride (PVC). The open cell structure allows sound waves incident thereon to penetrate therein rather than being reflected. These waves are thereby effectively removed from the acoustic spectrum, this resulting in a significantly reduced sound pressure in the adjacent space.

The acoustically damping effect of the wall covering can particularly be utilized to suppress reflection of speech in a busy space. Speech has a sound frequency which typically lies between 2000 Hz and 8000 Hz, which in air corresponds with an acoustic wavelength in the order of 4 to 20 centimetres. A particular embodiment of the wall covering according to the invention has been found highly suitable for absorbing these sound waves, which embodiment is characterized in that the drops have a thickness of a minimum of about 3 millimetres, and preferably a minimum of 7 millimetres. Surprisingly, it has been found that such a small thickness, this being an order of a tenth smaller than the wavelength of the sound in question, nevertheless already provides an adequate damping.

The adhesive layer between the top layer and the base layer advantageously comprises a heat-activated glue layer, a so-called hot melt. This has the advantage that the top layer can be positioned and aligned on the base layer without adhesion, and only then is a heat treatment performed in order to bring about the mutual adhesion. Even a less experienced skilled person or do-it-yourselfer should thus be capable of carrying this out properly.

The thermally activated adhesive layer is advantageously prearranged so that it need not be initially arranged during application of the material. In a first particular embodiment the wall covering according to the invention is for this purpose characterized in that the drops carry the adhesive layer at least partially on a front side thereof; in a second particular embodiment the wall covering according to the invention has the feature that the top layer carries the adhesive layer at least partially on a rear side thereof. Because the top layer need not have the acoustically damping properties which are already provided by the base layer, the top layer can take a relatively thin form. With a view to a thermally activated adhesive layer prearranged in the system it is therefore preferred to arrange the adhesive layer on the rear side of the top layer because it can be better mechanically processed owing to the smaller thickness.

For adhesion of the drops of the base layer to an underlying surface to be covered use can be made of a wide range of adhesives, wherein a sufficiently strong adhesion to be able to carry the relatively thick material of the base layer is provided for. For practical application of the wall covering according to the invention a further preferred embodiment thereof has the feature that the drops are provided on a rear side thereof with a pressure-sensitive adhesive layer. Such an adhesive layer, usually referred to as self-adhesive layer, can optionally be provided with a protective film, for instance of silicone paper, in order to protect the adhesive layer against contamination and degradation. On site the drops can simply be arranged with their rear side against the surface to be covered and pressed down in order to bring about the adhesion.

A method for applying the wall covering according to the invention has the feature that a number of successive drops of an acoustically damping material and a first thickness is glued at least substantially contiguously to the wall, that a top layer which is provided on a rear side thereof with a heat-activated adhesive layer is arranged covering at least a part of the drops, and that the top layer is subjected over at least substantially a whole surface thereof to a heat treatment which activates the activatable adhesive layer. The method particularly has the feature here that the heat treatment is performed with an iron. The top layer is here advantageously smoothed uniformly along the base layer in a first direction and here simultaneously adhered thereto in opposite direction by sliding the iron over the top layer and pushing it along in the first direction.

In a particular embodiment the wall covering according to the invention advantageously has the feature here that the top layer comprises a fleece, film or sheet, particularly a non-woven fleece. Such a fleece, film or sheet can in particular be applied particularly practically with an iron or the like. In a particular embodiment the wall covering according to the invention is further characterized here in that the top layer has a thickness of a maximum of 2 millimetres, and preferably a thickness of between 0.2 and 1.0 millimetre.

Application of such a relatively thin top layer, particularly in the form of a fleece, film or sheet, furthermore provides the advantage that this material can be printed up to a relatively great width in the order of two to three metres or even more with modern printers, wherein the material can for instance be supplied in practically unlimited length from a roll. A further particular embodiment of the wall covering and method according to the invention therefore have the feature that the top layer has on a visible side thereof a decorative print, particularly a full-surface print extending over at least a number of drops. This provides the option of covering for instance a wall of a space over a whole surface thereof with the wall covering according to the invention, wherein the top layer is arranged integrally thereover and has an uninterrupted decorative print.

The invention also relates to a top layer for application in the above described wall covering according to the invention, wherein the top layer is provided on a rear side thereof with a heat-activated adhesive layer which is able and configured to enter into an adhesion with the base layer.

The invention will be further elucidated hereinbelow with reference to an exemplary embodiment and an accompanying drawing. In the drawing:

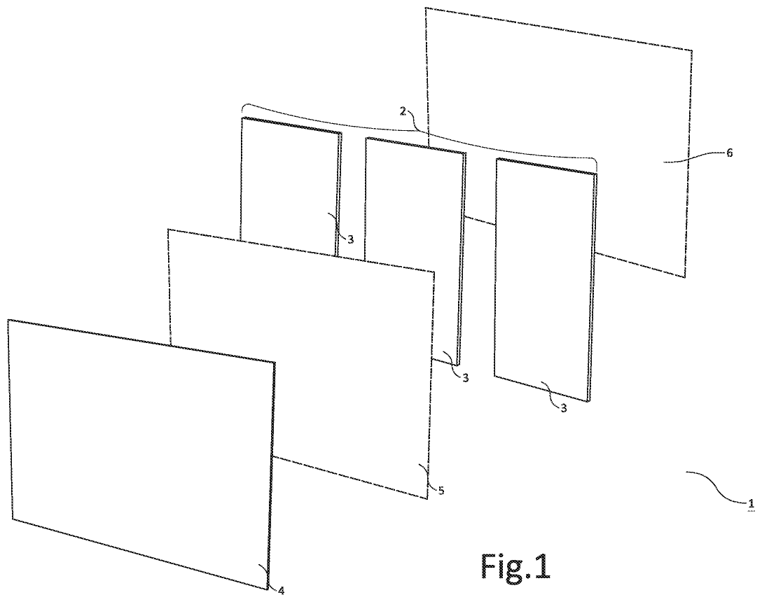

FIG. 1 is an exploded view of an embodiment of the wall covering according to the invention;

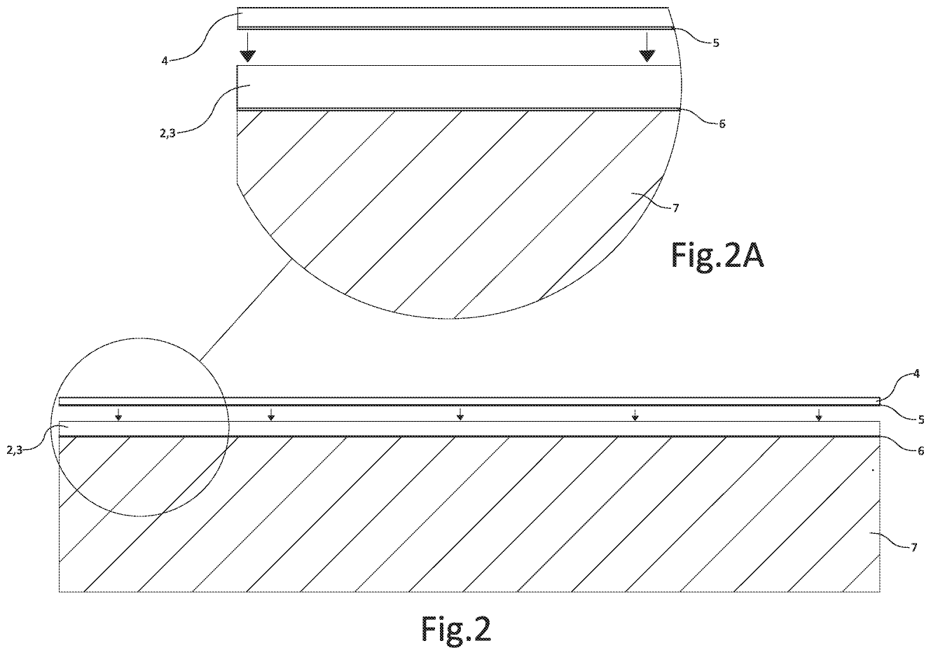

FIG. 2 is a side view of the wall covering of FIG. 1; and

FIG. 2A is a detail of the side view of FIG. 2.

It is otherwise noted here that the figures are purely schematic and not always drawn to (the same) scale. Some dimensions in particular may be exaggerated to greater or lesser extent for the sake of clarity. Corresponding parts are designated in the figures with the same reference numeral.

Referring to FIG. 1, a wall covering is referred to in general with reference numeral 1. The wall covering 1 comprises a base layer 2. Base layer 2 has a number of drops 3, these together stretching along a surface to be spanned, such as for instance a wall of a space or a part thereof. The drops 3 lie with their edges adjacently of each other and a desired length thereof is taken from a roll. An acoustically damping material has been used for the drops. This material has an open cell structure and comprises for instance a felt or a polymer foam with a thickness in the order of 7 millimetres. Particularly suitable for the material of base layer 2 in the context of the invention is felt or a polymer foam from a group of urea-formaldehyde foam (UF), polyurethane foam (PUR), polyisocyanurate foam (PIR), phenol formaldehyde foam (PF) and polyvinyl chloride foam (PVC).

On their rear side the drops 3 of base layer 2 are provided with an adhesive layer 6 whereby the drops 3 of base layer 2 adhere to the wall 7, see also FIG. 2. In this embodiment drops 3 are for this purpose provided beforehand with a pressure-sensitive adhesive layer 6, also referred to as self-adhesive layer. A protective film (not further shown), for instance of silicone paper, may be arranged on adhesive layer 6 in order to protect a contact surface of adhesive layer 6.

The wall covering further comprises a top layer 4 which extends over at least a set of drops 3 in order to thus conceal the seam therebetween, among other things, from view. In this embodiment the top layer 4 even extends over the whole base layer 2 in order to thus cover all drops 3 and intermediate seams. The top layer 4 is air-permeable so that sound waves are able to penetrate therethrough and are then subsequently absorbed in base layer 2 and acoustically damped. In this embodiment top layer 4 comprises a non-woven fleece, for instance of polyester or polyethylene fibres. A permeable film or a paper can instead also be applied.

A thickness of the top layer 4 lies in the order of several tenths of a millimetre to one or several millimetres, this being significantly thinner than that of base layer 2. The top layer can therefore be applied in relatively simple manner compared to the base layer. The top layer 4 applied here has a thickness of about 0.5 mm. Top layer 4 has on its front side a decorative print which can particularly be realized full-surface from a roll of the material, up to a width in the order of 3 metres and a practically unlimited length, with a standard sublimation printer or an inkjet printer. In the wall covering system described here the top layer 4 is applied with this width in height direction in order to thereby make it possible to realize a standard ceiling height in homes and other buildings.

The top layer is connected to drops 3 with interposing of a second adhesive layer 5. A heat-activated glue layer is used as adhesive layer 5. A copolyamide or copolyurethane adhesive system is for instance suitable for this purpose. This adhesive layer 5 can be prearranged on a rear side of top layer 4 and/or on a front side of the drops 3 of base layer 2. In this embodiment the adhesive layer 5 is provided on the rear side of top layer 4, as is shown in more detail in FIGS. 2 and 2A. The adhesive layer 5 can be activated by means of heat treatment, for which purpose use is in this embodiment made of an iron which is slid over the top layer.

In order to arrange the wall covering 1 on a wall 7 a number of drops 3 are adhered onto wall 7 in order to thereby cover the whole surface of wall 7. The drops 3 are adhered to a wall 7 by exerting pressure on drops 3, this activating the pressure-sensitive adhesive layer 6. This immediately brings about an adequate adhesion. If necessary due to the condition or composition of the base surface, the wall may be pretreated with a suitable primer in order to ensure this adhesion. The top layer 4 is now arranged over the drops 3, wherein intermediate seams in the base layer are covered up. The top layer is here placed with the rear side on base layer 2, for instance starting from a corner of the space in question, and optionally temporarily fixed with a tape.

An iron or the like is then slid over the top layer so as to apply a heat treatment which activates and simultaneously presses down the intermediate adhesive layer 5. An adhesion is thus immediately brought about between top layer 4 and base layer 2, whereby the top layer is secured durably onto base layer 2. This procedure is performed until the whole surface of top layer 4 has been treated. Any excess material of top layer 4 can be cut off in usual manner by means of a knife or the like in simple manner.

Owing to the invention, an aesthetically attractive acoustic wall covering can in the above described manner be arranged on a wall without having to compromise on acoustic functionality of the wall covering system as a whole. The air-permeable top layer 4 leaves the acoustic properties of the underlying base layer 2 unaffected but conceals the seams between the individual drop 3 in the base layer from view, while the top layer can if desired moreover have a full-surface and aesthetically attractive print. The overall thickness of the wall covering system, consisting of the base layer with the top layer thereon, remains relatively small so that a door jamb for example will still protrude above it.

Although the invention has been further elucidated above on the basis of only a single exemplary embodiment, it will be apparent that the invention is by no means limited thereto. On the contrary, many variations and embodiments are still possible within the scope of the invention for a person with ordinary skill in the art. One of the two or even both of the adhesive layers can for instance be applied during installation of the wall covering.

1. A wall covering comprising a base layer of a number of successive and mutually adjacent drops of an acoustically damping material and a first thickness, wherein the base layer is covered with an air-permeable top layer, wherein the top layer extends over at least a number of drops, and wherein the top layer is connected to the drops with interposing of a heat-activated adhesive layer.

2. The wall covering according to claim 1, wherein the top layer has a second, smaller thickness than the first thickness of the base layer.

3. The wall covering according to claim 1, wherein the drops collectively span a surface and wherein the top layer extends over the whole surface.

4. The wall covering according to claim 1, wherein the acoustically damping material has an open cell structure, particularly a felt or polymer foam with an open cell structure, more particularly a foam of a polymer from a group comprising urea-formaldehyde (UF), polyurethane (PUR), polyisocyanurate (PIR), phenol formaldehyde (PF) and polyvinyl chloride (PVC).

5. The wall covering according to claim 1, wherein the drops have a thickness of a minimum of about 3 millimetres, and preferably a minimum of 7 millimetres.

6. The wall covering according to claim 1, wherein the drops carry the adhesive layer at least partially on a front side thereof.

7. The wall covering according to claim 1, wherein the drops carry the adhesive layer at least partially on a rear side thereof.

8. The wall covering according to claim 1, wherein the drops are provided on a rear side thereof with a pressure-sensitive adhesive layer.

9. The wall covering according to claim 1, wherein the top layer comprises a fleece, film or sheet, particularly a non-woven fleece.

10. The wall covering according to claim 1, wherein the top layer has a thickness of a maximum of 2 millimetres, and preferably a thickness of between 0.2 and 1.0 millimetre.

11. The wall covering according to claim 1, wherein the top layer has on a visible side thereof a decorative print, particularly a full-surface print extending over at least a number of drops.

12. A top layer as applied in the wall covering according to claim 1, wherein the top layer is provided on a rear side thereof with a heat-activated adhesive layer.

13. A method for applying a wall covering, wherein at least a part of a wall is covered with the wall covering, wherein a number of successive drops of an acoustically damping material and a first thickness is glued at least substantially contiguously to the wall, wherein a top layer which is provided on a rear side thereof with a heat-activated adhesive layer is arranged covering at least a part of the drops, and wherein the top layer is subjected over at least substantially a whole surface thereof to a heat treatment which activates the activatable adhesive layer.

14. The method according to claim 13, wherein the heat treatment is performed with an iron.

15. The method according to claim 13, wherein the top layer was preprinted with a decorative print.

16. The method according to claim 15, wherein the print was realized with a sublimation printer or an inkjet printer.
